(19) United States
(12) Patent Application Publication
(10) Pub. No.: US 2001/0023056 A1
(43) Pub. Date: Sep. 20, 2001

(54) Dental device

(75) Inventors: Robert Grunenfelder, Liechtenstein (CH); Johanner Lorunser, Bludenz (AT); Gottfried Rohner, Altstatten (CH)

Correspondence Address: John C. Thompson, 69 Grayton Road, Tonawanda, NY, 14150, US

(73) Assignee: Ivoclar Vivadent AG

(21) Appl. No.: 09/809,879

(22) Filed: Mar. 16, 2001

Related U.S. Application Data
(60) Provisional application No. 60/204,996, filed on May 16, 2000.

(30) Foreign Application Priority Data
Mar. 15, 2000 (DE) P 100 12 632,4

(51) Int. Cl. A61C 3/00

(52) U.S. Cl. 433/27

(57) ABSTRACT

A dental device intended for performing a dental process with a program control that controls at least one parameter curve of the dental device during the process. It includes a cut-off apparatus that turns the dental device off at some time after the beginning of the process when the process has concluded. The device includes a pager that is connected to the program control, and the pager is activateable near the end of the process or directly upon conclusion of the process. Preferably, the pager is a wireless pager.

### BACKGROUND OF THE INVENTION

The present invention relates to a dental device for performing a dental process with a program control that controls at least one parameter curve of the dental device during the process, including a cut-off apparatus that turns the dental device off at some time after the beginning of the process when the process has concluded.

Such dental devices are employed in broad areas when the goal is to perform dental processes efficiently. An example thereof is a scalding unit for wax used in producing a prosthesis or a steam jet device for cleaning the prosthesis. A scalding unit heats a model beyond the melting point of the wax but clearly below the melting point of other materials that are used for producing the present prosthesis.

Naturally, there is a cooling period once the scalding process has concluded. However, unless an operator intervenes, the model at first remains relatively warm in the scalding unit, whereby it is subjected to a certain load and can even be damaged. It would be helpful for the operator to wait through the scalding process until it was time to remove the model. On the other hand, it is desirable that qualified dental technicians not spend their time waiting, and the dental technician would also be regularly able to accomplish other work if he or she did not have to monitor the dental device.

Similar situations arise in conjunction with many other devices in the field of dentistry, e.g. sterilizers, preheaters, steam jet devices, and even galvanizers, casting devices or milling devices, and polymerizing devices.

In addition, furnaces (e.g. pressure furnaces) are widely used today as dental devices in order to fire ceramic restorations such as, e.g., crowns and bridges in what is known as a muffle. The ceramic to be sintered is inserted in the muffle into the furnace and there it is subjected to a precisely defined firing process with exact values in terms of the pressure applied and in terms of the temperature used. The technology for producing prosthetic parts is currently highly refined because the objective is to provide high dimensional accuracy in order to obtain a good fit. Even given the casting, modeling, production of a negative cast, and other additional steps required for producing the mold, the pressure furnace frequently represents a certain bottleneck in the prosthesis production process, particularly since these furnaces are among the more expensive pieces of equipment in the dental laboratory due to the costly technology they employ, the special controls, the pressure sealing, etc., and it is consequently not possible to procure large numbers of them.

In order to improve throughput, but also for other reasons, so-called preheaters are frequently used when pressing ceramics; the muffle is preheated to a certain temperature, e.g. 700° C., in the preheaters. The muffle can then be introduced into the pressure furnace already warm so that the duration of the firing cycle is reduced correspondingly.

In general dental laboratories encompass several rooms, equipment that is functionally related being arranged in adjacent positions (like pressure furnace and preheater). The dental technician then remains in this room, which is generally warm, for as long as he or she is busy using this device or an associated device in the same room and then the technician leaves the room.

So that the dental technician does not have to keep a constant eye on the firing furnace, the firing furnace opens automatically at the end of the firing cycle and the muffle consequently begins to cool. However, the furnace itself also begins to cool. This loss of heat, and thus the substantial losses for re-heating, which also lead to a corresponding delay, must be taken into account because it is important not to over-fire the muffle, i.e., not to leave the muffle in the closed and therefore hot firing furnace after the firing process has concluded.

It has therefore been suggested that firing furnaces be provided with acoustic signals that indicate the end of the firing process. However, such an acoustic signal is not reliable unless an appropriate volume is used. When a dental technician is busy using another device, e.g. a mixer, in another room, and that other device itself makes noise, the technician will not be able to hear the acoustic signal unless it is loud enough to carry into the room in which the technician is now working. However, a signal with a volume that high is excessively loud if the dental technician is still working in the room in which the pressure furnace is located.

Furthermore, in the field of foundries, i.e. for melting furnaces for aluminum, etc., it has been suggested that special alarm systems be used that provide a signal when the furnace malfunctions and prevent the furnace from being turned back on too early. Since an aluminum plant can extend over a significant distance, it has also been suggested that the alarm signal be provided remotely, e.g. over a telephone connection, a fixed radio link, or a fixed line. But the conditions are not comparable.

Furthermore disadvantageous in the known firing furnaces for dental materials is that the dental technician that is doing other work during the firing process must accomplish this other work with the added pressure of not missing the end of the firing process and not missing the acoustic signal, if any. The dental technician could use a timer to help keep track of the time. However, since such a timer is not otherwise required in the dental laboratory, it would have to be procured as a special item. More important in this context is that the time differential between the time set on the timer and the time the firing begins introduces an element of uncertainty, especially since different firing programs have different running times, some of which depend on the starting temperature of the firing furnace, which the dental technician would therefore not be able to estimate with precision. Thus in this situation a timer does not qualify as a suitable aid.

The object of the invention is therefore to create a dental device for performing a dental process of the type previously described that makes possible more rapid operation for efficient performance of tasks in the dental laboratory. More rapid re-use of the dental device than previously was the case is to be enabled. Prompt removal of the article being treated is to be more certain.

### SUMMARY OF THE INVENTION

This object is achieved in accordance with the invention in that the program control is attached to a pager, especially a wireless pager, that can be activated near the end of the process or directly upon conclusion of the process.

In accordance with the invention, it is favorable that the dental device in accordance with the invention can be used optimally in terms of time without there being a negative impact on the productivity of the dental technician or other operators. This makes it possible to prevent the dental article from remaining in the dental device and incurring damage, even after the device has turned off.

The solution in accordance with the invention ensures that the dental technician is always made aware of the end of the dental device process at the correct time so that he or she can remain at his or her workstation and work undisturbed without having to pay attention to the firing process. In accordance with the invention, a wireless pager is used that encompasses a transmitter that is linked to the program control of the dental device and that is activated when the process concludes or near the end of the process.

The transmitter has a certain code that addresses the receiver. The dental technician carries the receiver, which can be extremely small, e.g. only a few centimeters in length. It signals the conclusion of the process acoustically, visually, and/or by vibrating. Surprisingly, this simple measure assures that utilization of the dental device is optimized, as is energy consumption. It ensures that, e.g., no furnace is left open for minutes at a time, thus cooling, without the knowledge of the dental technician.

In accordance with an additional advantageous aspect of the invention, the dental device in accordance with the invention with wireless pager can assure unique identification of the calling dental device. The code is employed for this. For example, when an additional dental device, for which the dental technician is not responsible, but for which a different dental technician is responsible, is installed in close physical proximity to the relevant dental device, the code can factor this in with nothing further so that the dental technician's receiver addresses only the transmitter of the dental device for which he or she is responsible.

In accordance with an advantageous embodiment it is also possible to monitor a plurality of dental devices in parallel such that each dental device triggers different signals in the same receiver, which is ready to receive two different codes in order to make it possible to differentiate the dental device that has reached the end of its process.

Furthermore, it is also possible to indicate the status of the process using additional different signals. Thus the operator can be kept continuously informed of whether the process is running smoothly or whether there has been an error.

### BRIEF DESCRIPTION OF THE DRAWING

Additional advantages, details, and features can be appreciated from the following description of an exemplary embodiment of the invention using the drawings. A pressure furnace for ceramics is described as an example of a dental device.

FIG. 1 is a diagram of a furnace as an example of a dental device in accordance with the invention, to which is attached a transmitter for a pager in accordance with the invention;

FIG. 2 is a diagram of a receiver for the pager; and

FIG. 3 is a circuit diagram of the furnace in accordance with the invention with the pager.

### DESCRIPTION OF PREFERRED EMBODIMENTS

The furnace or kiln 10 illustrated in FIG. 1 has a cover 12 and a bottom part 14. A muffle furnace, or muffle 16, shown in phantom, stands on a plate of the bottom part 14 and is enclosed by the cover 12. The cover 12 has in its interior a heating apparatus, known per se, that surrounds and heats the muffle on all sides.

The furnace 10 shown in FIG. 1 has two work surfaces 18 and 20 that are for preparing the next muffle and for the finished muffle after the firing process concludes. For this the cover 12 is lifted so that it uncovers the muffle 16. This occurs automatically via a program control that is located in the furnace 10. The program control is operated by means of a control panel 22 that is attached to the front of the furnace and that also permits various displays, e.g. a graphic display field for the desired firing curves that are to be programmed.

At the end of the firing process, the cover 12 opens automatically, wherein it first raises slightly and then swings up. In this condition the muffle 16 cools and it would be possible to remove it and let it cool on the work surface 20 and to insert the next muffle from the work surface 18.

In accordance with the invention, a pager 24 is provided, the transmitter 26 of which is illustrated in FIG. 1. The transmitter 26 is linked to the program control and is activated shortly before the firing process in the firing furnace 10 concludes and the cover 12 opens. It will be appreciated that the time until the actual end of the firing process can be adapted to requirements. For instance, a period of minus five seconds is possible, that is, five seconds prior to the cover 12 opening. The end of the process is indicated directly on the pressure furnace.

In a further embodiment of the invention it is provided that the period is selectable so that the user himself can set as much warning time as he wants, if indeed he wants any warning time at all.

The transmitter emits an encoded signal. The carrier signal can be amplitude-modulated, frequency-modulated, or, e.g. pulse-width-modulated, whereby the code selected can be embodied to be variable as needed in order, e.g. to make it possible to operate a plurality of furnaces in parallel.

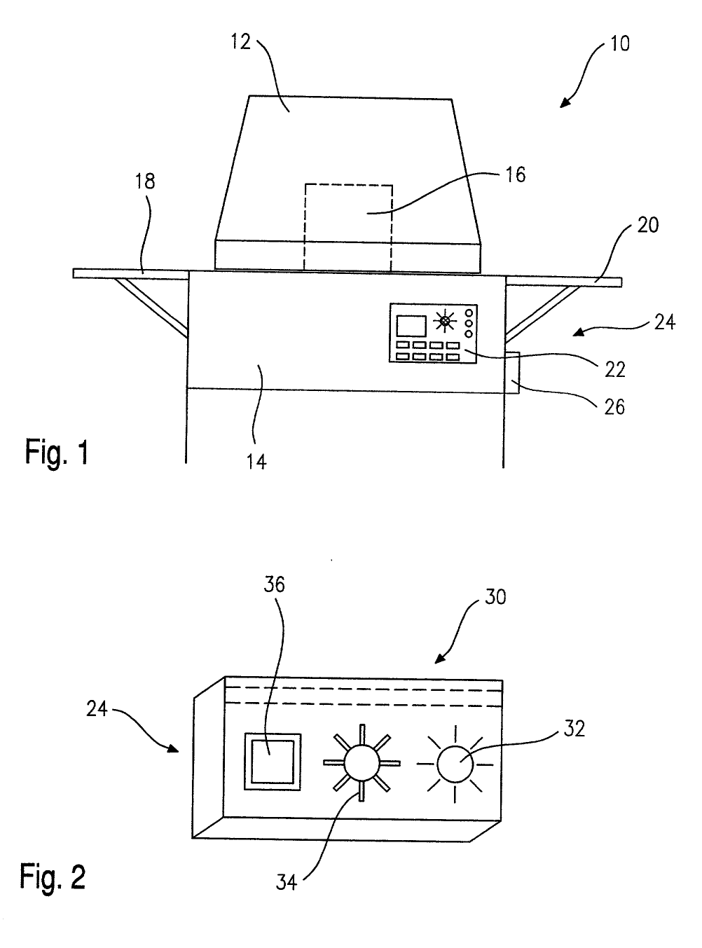

FIG. 2 illustrates a receiver 30 of the pager 24. The receiver 30 is an exceptionally thin unit that is, e.g. 2 cm in length, 1 cm in height, and e.g. 5 mm thick. It has a decoder that is tuned to the encoder in the transmitter 26 so that it is activated when the transmitter emits signals intended for the receiver 30. In the exemplary embodiment illustrated, the signaling is both visual via a light emitting diode 32 and acoustic via a buzzer 34. Furthermore provided is a small button 36 that acts on a key with which the signals for the buzzer and light diode can be turned off. The receiver 30 is battery-operated and, despite its compactness, also has a small antenna in order to be able to acquire the information transmitted over the distance required.

As soon as the dental technician detects a signal from the receiver, he or she turns the signal off and goes to the paging furnace in order to remove the muffle 16 and insert the next muffle, if any. He or she is then free to resume working immediately. This is also true when he or she is already located in the same room as the furnace.

In a modified embodiment of the receiver, it is provided that a vibrating element be installed that then can use its signal function when the receiver is carried, e.g. in a shirt pocket.

In a further modified embodiment, it is provided that the type of signaling can be switched in a sequential rotation, e.g. acoustic −visual -acoustic +visual, by means of actuating the button 36.

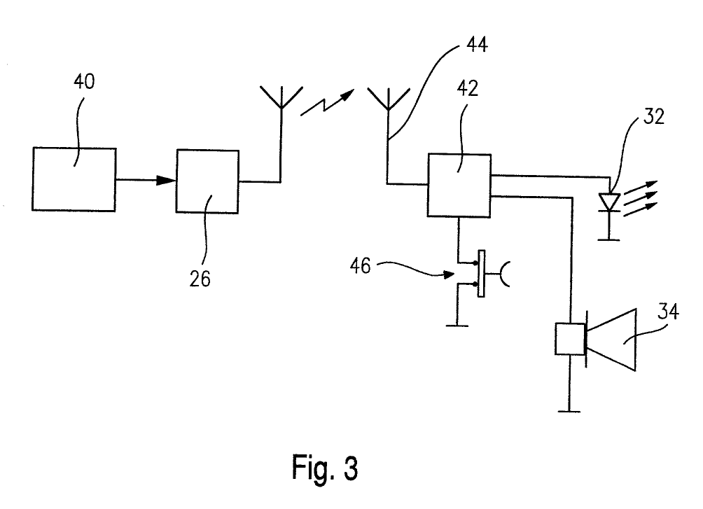

FIG. 3 is the circuit diagram of a pager in accordance with the invention. A program control 40 triggers the transmitter 26, which is itself connected to a transmitting antenna. If lead time is desired between signaling and the end of the firing process, it is useful not to obtain the control signal for the transmitter directly from the end of program, but rather from the program control itself, which has available a corresponding control logic and timer.

The receiver 30 has a receiving circuit 42 that is connected to a receiver antenna 44. Its output is connected both to the light diode 32 and to the buzzer 34. It is appreciated that a small speaker can also be used instead of the buzzer 34. The receiving circuit 42 also has a decoding apparatus. It is furthermore connected to a key 46 that is actuated by means of the button 36. When the button 36 is actuated, the display is disabled for a certain period, e.g. 10 seconds, so that the dental technician has enough time to perform the necessary steps at the furnace. In accordance with the invention, the transmitted signal is suppressed by a desired operating function that the dental technician undertakes at the furnace. For instance, if he or she turns the furnace off because no further firing process is required, the signal for the transmitter is also turned off. This also applies in the same way to starting a new firing cycle with the next muffle. In each case, it is useful in accordance with the invention for the receiver not to be reactivated, or be “sharp”, until the usual operating time for the corresponding process has been exceeded so that no false alarm occurs.

It will be appreciated that additional modifications are possible without deviating from the scope of the invention. For instance, the solution in accordance with the invention can also be readily used on any dental devices other than firing furnaces and pressure furnaces in which efficient production is desired and in which the pertinent dental restorations remain in the pertinent device for an extended period and are produced automatically.

In accordance with a further, particularly favorable embodiment of the invention, it is provided that the conclusion of the process be signaled via an available connection. For instance, the telecommunications system of a network of available PCs can be used for this. Another option is signaling via special lines via which the dental devices can exchange data with each other.

The specification incorporates by reference the disclosure of German priority document P 100 12 632.4.

The present invention is, of course, in no way restricted to the specific disclosure of the specification and drawings, but also encompasses any modifications within the scope of the appended claims.

What is claimed is:

1. A dental device for performing a dental process with a program control that controls at least one parameter curve of the dental device during the process, and including a cut-off apparatus that turns the dental device off at some time after the beginning of the process when the process has concluded, said device comprising:
a pager that is connected to said program control, wherein said pager is activateable near the end of the process or directly upon conclusion of the process.

2. A dental device according to claim 1, wherein said pager is a wireless pager.

3. A dental device according to claim 2, wherein said wireless pager is activateable shortly prior to the end of the process.

4. A dental device according to claim 2, wherein said wireless pager is provided with a transmitter that is connected to a switch output of said program control

5. A dental device according to claim 2, wherein said wireless pager is provided with a mobile, battery or cell operated receiver that has an acoustic and/or visual display or a vibrating element.

6. A dental device according to claim 5, wherein said transmitter of said wireless pager is provided with an encoder, wherein said receiver is provided with a decoder, and wherein said receiver permits unique identification of a signaling dental device.

7. A dental device according to claim 1, wherein said pager is also adapted to signal a dental device error, especially with a signal that differs from a signal for the end of the process.

8. A dental device according to claim 4, wherein said wireless pager is provided with a modular transmitter by means of which existing dental devices can be retrofitted.

9. A dental device according to claim 5, wherein said receiver is provided with a reset key by means of which an operator can reset an alarm after noting such alarm.

10. A dental device according to claim 4, wherein said transmitter has a transmit power of less than 500 milliwatts, and a range that is limited to about 100 m.

11. A dental device according to claim 10, wherein said transmit power is about 50 milliwatts.

12. A dental device according to claim 1, wherein said dental device is embodied as a firing or pressure furnace or a preheater for dental ceramics.

13. A dental device according to claim 1, wherein said dental device is embodied as a polymerization device for hardening dental restorations, or as a scalding unit or steam jet device for producing dental prostheses.

14. A dental device according to claim 1, wherein said dental device is embodied as a milling device, especially in CAD/CAM technology, or as a galvanizer for producing dental restorations.

15. A dental device according to claim 1, wherein said dental device is embodied as a metering, mixing, casting, or sterilizing device for producing teeth and/or dental restorations.

16. A dental device according to claim 1, wherein a time between the beginning of the process and the end of the process is between 10 minutes and 10 hours, especially between 15 minutes and 2 hours.

17. A dental device according to claim 1, wherein said pager is embodied as a telecommunications apparatus that signals the conclusion of the process via a connection.

18. A dental device according to claim 17, wherein said connection is an in-house network and its telecommunication function.
